(19) United States
(12) Patent Application Publication
(10) Pub. No.: US 2025/0015406 A1
(43) Pub. Date: Jan. 9, 2025

(54) ENERGY STORAGE CELL, ARRAY OF ENERGY STORAGE CELLS, AND MANUFACTURING PROCESS

(71) Applicant: VARTA MICROBATTERY GMBH, Ellwangen Jagst (DE)

(72) Inventors: Edward PYTLIK, Ellwangen (DE); Dominik KIENINGER, Rainau (DE); David ENSLING, Ellwangen (DE)

(21) Appl. No.: 18/712,255

(22) PCT Filed: Nov. 24, 2022
(86) PCT No.: PCT/EP2022/083072

§ 371 Date: May 22, 2024

(30) Foreign Application Priority Data
Nov. 24, 2021 (EP) 21210297.4

(51) Int. Cl. H01M 50/184; H01M 10/0587; H01M 50/107; H01M 50/119; H01M 50/152; H01M 50/167; H01M 50/193; H01M 50/531; H01M 50/559

(52) U.S. Cl. CPC H01M 50/184; H01M 10/0587; H01M 50/107; H01M 50/119; H01M 50/152; H01M 50/167; H01M 50/193; H01M 50/531; H01M 50/559

(57) ABSTRACT

An energy storage cell includes an electrode-separator assembly winding with a first terminal end face, a second terminal end face, and a winding shell located therebetween. The energy storage cell further includes an airtight and liquid-tight housing that includes a metallic housing cup with a terminal circular opening, a lid assembly with a circular edge, and an annular seal that encloses the circular edge and electrically insulates the housing cup and the lid assembly from one another. The metallic housing cup includes a central section and a closure section. In the closure section, the annular seal is in press contact with the lid assembly and the metallic housing cup has an opening edge that is bent radially inwards over the circular edge of the lid assembly. A wall thickness of the radially inwardly bent opening edge is greater than a wall thickness of the central section.

### CROSS REFERENCE TO RELATED APPLICATIONS

This application is a U.S. National Phase application under 35 U.S.C. § 371 of International Application No. PCT/EP2022/083072, filed on Nov. 24, 2022, and claims benefit to European Patent Application No. EP 21210297.4, filed on Nov. 24, 2021. The International Application was published in German on Jun. 1, 2023 as WO 2023/094498 under PCT Article 21(2).

### FIELD

The present disclosure relates to an energy storage cell, an array of energy storage cells, and a manufacturing method for an array of energy storage cells.

### BACKGROUND

Electrochemical energy storage elements can convert stored chemical energy into electrical energy through virtue of a redox-reaction. The simplest form of an electrochemical energy storage element is the electrochemical cell. It comprises a positive and a negative electrode, which are separated from each other by a separator. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current crosses the separator and is made possible by an ion-conducting electrolyte.

If the discharge is reversible, i.e. it is possible to reverse the conversion of chemical energy into electrical energy during discharge and charge the cell again, this is said to be a secondary cell. The common designation of the negative electrode as the anode and the designation of the positive electrode as the cathode in secondary cells refers to the discharge function of the electrochemical cell.

Secondary lithium-ion cells are used as energy storage elements for many applications today, as they can provide high currents and are characterized by a comparatively high energy density. They are based on the use of lithium, which can migrate back and forth between the electrodes of the cell in the form of ions. The negative electrode and the positive electrode of a lithium-ion cell are generally formed by so-called composite electrodes, which comprise electrochemically inactive components as well as electrochemically active components.

In principle, all materials that can absorb and release lithium ions can be used as electrochemically active components (active materials) for secondary lithium-ion cells. For example, carbon-based particles such as graphitic carbon are used for the negative electrode. Active materials for the positive electrode can be, for example, lithium cobalt oxide (LiCoO₂), lithium manganese oxide (LiMn₂O₄), lithium iron phosphate (LiFePO₄) or derivatives thereof. The electrochemically active materials are generally contained in the electrodes in particle form.

As electrochemically inactive components, the composite electrodes generally comprise a flat and/or strip-shaped current collector, for example a metallic foil, which serves as a carrier for the respective active material. The current collector for the negative electrode (anode current collector) can be made of copper or nickel, for example, and the current collector for the positive electrode (cathode current collector) can be made of aluminum, for example. Furthermore, the electrodes can comprise an electrode binder (e.g. polyvinylidene fluoride (PVDF) or another polymer, for example carboxymethyl cellulose), conductivity-improving additives and other additives as electrochemically inactive components. The electrode binder ensures the mechanical stability of the electrodes and often also the adhesion of the active material to the current collectors.

As electrolytes, lithium-ion cells generally comprise solutions of lithium salts such as lithium hexafluorophosphate (LiPF₆) in organic solvents (e.g. ethers and esters of carbonic acid).

The composite electrodes are combined with one or more separators to form an assembly when manufacturing a lithium-ion cell. For this purpose, the electrodes and separators can be joined together under pressure, possibly also by lamination or bonding. Very often, the electrodes and separators are also combined in a winding machine. The basic functionality of the cell can then be established by impregnating the assembly with the electrolyte.

In many embodiments, the assembly is produced in the form of a winding or processed into a winding. It generally comprises the sequence positive electrode/separator/negative electrode. Assemblies are often produced as so-called bi-cells with the possible sequences negative electrode/separator/positive electrode/separator/negative electrode or positive electrode/separator/negative electrode/separator/positive electrode.

For applications in the automotive sector, for e-bikes or for other applications with high energy requirements, such as in tools, lithium-ion cells with the highest possible energy density are required that are also capable of withstanding high currents during charging and discharging.

Cells for the aforementioned applications are often designed as cylindrical round cells, for example with the form factor 21×70 (diameter*height in mm) Cells of this type always comprise an assembly in the form of a winding. Modern lithium-ion cells of this form factor can already achieve an energy density of up to 270 Wh/kg. However, this energy density is only considered an intermediate step. The market is already demanding cells with even higher energy densities.

In WO 2017/215900 A1, cylindrical round cells are described in which the electrode-separator assembly is shaped as a winding and comprises ribbon-shaped electrodes. The electrodes each have current collectors loaded with electrode material. Oppositely polarized electrodes are arranged offset to each other within the electrode-separator assembly so that longitudinal edges of the current collectors of the positive electrodes protrude from the winding on one side and longitudinal edges of the current collectors of the negative electrodes protrude from the winding on another side. For electrical contacting of the current collectors, the cell has a contact plate that sits on one end face of the winding and is welded to a longitudinal edge of one of the current collectors. This makes it possible to electrically contact the current collector and thus also the associated electrode over its entire length. This significantly reduces the internal resistance within the described cell. As a result, the occurrence of large currents can be absorbed much better and heat can also be dissipated better from the winding.

Cylindrical round cells such as those in WO 2017/215900 A1 are often used as part of a cell array in which several cells are connected in series and/or in parallel. It is desirable to contact the cells only at one of their end faces in order to tap an electrical voltage. Accordingly, it is advantageous to provide both a connection pole connected to the positive electrode of the cell and a connection pole connected to the negative electrode of the cell on one of the end faces.

The housing of cylindrical round cells generally comprises a housing cup, which contains the wound electrode-separator assembly, and a lid assembly, which closes the opening of the housing cup. A seal is arranged between the lid assembly and the housing cup, which serves to seal the cell housing on the one hand, but also has the function of electrically insulating the lid assembly and the housing cup from each other. The seal is usually mounted on the edge of the lid assembly. To close the round cells, the opening edge of the housing cup is generally bent radially inwards over the edge of the lid assembly on which the seal is mounted (crimping process), so that the lid assembly including the seal is positively fixed in the opening of the housing cup.

An example of such a round cell is shown in FIG. 3 of EP 3188280 A1. It is relatively easy to weld the lid assembly (reference number 270) to a suitable conductor rail in order to integrate the cell shown into a cell array; the protruding pole cap (reference number 217) offers the best conditions for this. However, the electrical connection of the housing cup is more difficult. If you want to contact the housing cup on the same end face on which the lid assembly is located, the conductor rail can only be welded to the radially inwardly bent opening edge (reference number 213) of the housing cup. The problem with this is that welding can easily damage the seal, which is in direct contact with the bent opening edge, as it is sensitive to thermal stresses that typically occur during welding. Round cells with a classic cell housing such as that described in FIG. 3 of EP 3188280 A1 are therefore not intended for welding a current conductor to the opening edge.

EP 3537496 A1 and JP 2012-174523 A disclose lithium-ion cells in which a lid assembly is inserted into the opening of a housing cup, with the edge of the housing cup being folded over in a U-shape at the end to protect against corrosion.

JP 2007-234305 A discloses a cell housing for an alkaline cell comprising a housing cup with a thicker reinforced edge. The edge of the cup is thicker than the other parts of the cup in order to prevent damage to the edge during mechanical cell closure by a crimping process.

### SUMMARY

In an embodiment, the present disclosure provides an energy storage cell. The energy storage cell includes an electrode-separator assembly in the form of a cylindrical winding with a first terminal end face, a second terminal end face, and a winding shell located therebetween. The electrode-separator assembly includes an anode, a cathode, and at least one separator in a sequence anode/separator/cathode. The energy storage cell further includes an airtight and liquid-tight housing that includes a metallic housing cup with a terminal circular opening, a lid assembly with a circular edge that closes the terminal circular opening, and an annular seal that encloses the circular edge of the lid assembly and electrically insulates the housing cup and the lid assembly from each other. The metallic housing cup includes, in axial sequence, a bottom, a central section, and a closure section. The central section is cylindrical and the winding shell of the electrode-separator assembly contacts an inside of the metallic housing cup in the central section. In the closure section, the annular seal is in press contact with the lid assembly and the inside of the metallic housing cup and the metallic housing cup has an opening edge that defines the circular opening and is bent radially inwards over the circular edge of the lid assembly. The opening edge positively fixes the lid assembly and the annular seal in the circular opening of the housing cup. A wall thickness of the radially inwardly bent opening edge is greater than a wall thickness of the central section.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a first embodiment of an energy storage cell (cross-sectional view);

FIG. 2 provides a general view (cross-sectional view) of the energy storage cell shown in FIG. 1;

FIG. 3 illustrates a second embodiment of an energy storage cell (cross-sectional view);

FIG. 4 illustrates a third embodiment of an energy storage cell (cross-sectional view);

FIG. 5 illustrates a lid assembly as used in the embodiments of the energy storage cell as shown in FIGS. 1 to 4 (cross-sectional view);

FIG. 6 illustrates an electrode-separator assembly, which is part of an energy storage cell, and its components;

FIG. 7 illustrates an energy storage cell with two welded-on electrical conductors;

FIG. 8 illustrates an enlarged view of weld seams; and

FIG. 9 illustrates a top view of a lid component of a cell as shown in FIG. 2.

### DETAILED DESCRIPTION

The present disclosure provides energy storage cells that are characterized by a high energy density and that can be efficiently integrated into a cell array. Furthermore, the present disclosure provides energy storage cells characterized by improved safety.

### Energy Storage Cell

An energy storage cell according to the present disclosure has the following features a. to f:
a. The cell comprises an electrode-separator assembly with the sequence anode/separator/cathode,
b. the electrode-separator assembly is in the form of a cylindrical winding with a first and a second terminal end face and a winding shell in between,
c. the cell comprises an airtight and liquid-tight housing comprising a metallic housing cup with a terminal circular opening and a lid assembly with a circular edge which closes the circular opening,
d. the cell comprises an annular seal made of an electrically insulating material which encloses a circular edge of the lid assembly and electrically insulates the housing cup and the lid assembly from each other,
e. the housing cup comprises, in axial sequence, a bottom, a central section and a closure section, wherein
   the central section is cylindrical and in the central section the winding shell of the electrode-separator assembly is in contact with the inside of the housing cup, and
   in the closure section, the annular seal is in a press contact with the lid assembly and the inside of the housing cup, and
f. in the closure section, the housing cup has an opening edge defining the circular opening, which is bent radially inwards over the edge of the lid assembly, which is enclosed by the seal, wherein the opening edge positively fixes the lid assembly including the seal in the circular opening of the housing cup.

The energy storage cell is characterized by the feature that:
g. the wall thickness of the radially inwardly bent opening edge of the housing cup is greater than the wall thickness of the housing cup in the central section.

This measure ensures that conductor rails can be welded onto the radially inwardly bent opening edge of the housing cup without problems with the seal. The increased thickness of the opening edge ensures that the heat generated during welding can be better distributed, so that local overheating and melting of the seal can be avoided.

The electrode-separator assembly is preferably in direct contact with the inside of the housing cup. It is preferably in direct contact with the inside of the housing cup. In some embodiments, however, it may be provided to electrically insulate the inside, for example by means of a foil. In this case, the electrode-separator assembly is in contact with the inner wall via the foil.

The bottom of the housing cup is preferably circular. The housing cup is usually formed by deep drawing. However, it is also possible to form the cup by welding a bottom into a tubular half-part.

The energy storage cell is preferably a cylindrical round cell. Accordingly, the electrode-separator assembly preferably comprises the anode and the cathode in the form of ribbons. In addition, it preferably comprises a ribbon-shaped separator or two ribbon-shaped separators. The end faces are preferably bounded by a circular edge.

The height of the energy storage cell according to the invention is, when it is designed as a cylindrical round cell, preferably in the range from 50 mm to 150 mm. Its diameter is preferably in the range from 15 mm to 60 mm. Cylindrical round cells with these form factors are particularly suitable for supplying power to electric drives in motor vehicles.

### Embodiment as a Lithium-Ion Cell

In a preferred embodiment, the energy storage cell is a lithium-ion cell.

Basically, all electrode materials known for secondary lithium-ion cells can be used for the electrodes of the energy storage cell.

Carbon-based particles such as graphitic carbon or non-graphitic carbon materials capable of intercalating lithium, preferably also in particle form, can be used as active materials in the negative electrodes. Alternatively or additionally, lithium titanate (Li₄T₁₅O₁₂) or a derivative thereof can also be contained in the negative electrode, preferably also in particle form. Furthermore, the negative electrode can contain as active material at least one material from the group comprising silicon, aluminum, tin, antimony or a compound or alloy of these materials that can reversibly store and release lithium, for example silicon oxide (in particular SiOₓ with 0<x<2), optionally in combination with carbon-based active materials. Tin, aluminum, antimony and silicon can form intermetallic phases with lithium. The capacity to absorb lithium exceeds that of graphite or comparable materials many times over, especially in the case of silicon. Mixtures of silicon and carbon-based storage materials are often used. Thin anodes made of metallic lithium are also suitable.

Suitable active materials for the positive electrodes include lithium metal oxide compounds and lithium metal phosphate compounds such as LiCoO₂ and LiFePO₄. Lithium nickel manganese cobalt oxide (NMC) with the chemical formula LiNiₓMn_{y}Co_{z}O₂ (where x+y+z is typically 1) is also particularly suitable, lithium manganese spinel (LMO) with the chemical formula LiMn₂O₄, or lithium nickel cobalt aluminum oxide (NCA) with the chemical formula LiNiₓCo_{y}Al_{z}O₂ (where x+y+z is typically 1). Derivatives thereof, for example lithium nickel manganese cobalt aluminum oxide (NMCA) with the chemical formula Li_{1.11}(Ni_{0.40}Mn_{0.39}Co_{0.16}Al_{0.05})_{0.89}O₂ or Li₁₊ₓM-O compounds and/or mixtures of the aforementioned materials can also be used. The cathodic active materials are also preferably used in particulate form.

In addition, the electrodes of an energy storage cell preferably contain an electrode binder and/or an additive to improve the electrical conductivity. The active materials are preferably embedded in a matrix of the electrode binder, with neighboring particles in the matrix preferably being in direct contact with each other. Conductive agents have the function of increasing the electrical conductivity of the electrodes. Common electrode binders are based, for example, on polyvinylidene fluoride (PVDF), (Li-)polyacrylate, styrene-butadiene rubber or carboxymethyl cellulose or mixtures of different binders. Common conductive agents are carbon black, fine graphite, carbon fibers, carbon nanotubes and metal powder.

The energy storage cell preferably comprises an electrolyte, in the case of a lithium-ion cell in particular an electrolyte based on at least one lithium salt such as lithium hexafluorophosphate (LiPF₆), which is present dissolved in an organic solvent (e.g. in a mixture of organic carbonates or a cyclic ether such as THF or a nitrile). Other lithium salts that can be used are, for example, lithium tetrafluoroborate (LiBF₄), lithium bis(trifluoromethanesulfonyl)imide (LiTFSI), lithium bis(fluorosulfonyl)imide (LiFSI) and lithium bis(oxalato)borate (LiBOB).

The nominal capacity of a lithium-ion-based energy storage cell designed as a cylindrical round cell is preferably up to 15000 mAh. With the form factor of 21×70, the energy storage cell in one embodiment as a lithium-ion cell preferably has a nominal capacity in the range from 1500 mAh to 7000 mAh, preferably in the range from 3000 to 5500 mAh. With the form factor of 18×65, the cell in one embodiment as a lithium-ion cell preferably has a nominal capacity in the range from 1000 mAh to 5000 mAh, preferably in the range from 2000 to 4000 mAh.

In the European Union, manufacturers' information on the nominal capacity of secondary batteries is strictly regulated. For example, information on the nominal capacity of secondary nickel-cadmium batteries must be based on measurements in accordance with the IEC/EN 61951-1 and IEC/EN 60622 standards, information on the nominal capacity of secondary nickel-metal hydride batteries must be based on measurements in accordance with the IEC/EN 61951-2 standard, information on the nominal capacity of secondary lithium batteries must be based on measurements in accordance with the IEC/EN 61960 standard and information on the nominal capacity of secondary lead-acid batteries must be based on measurements in accordance with the IEC/EN 61056-1 standard. Any information on nominal capacities in the present application is preferably also based on these standards.

### Sodium-Ion-Based Embodiment

In further embodiments, the energy storage cell may also be a sodium-ion cell, a potassium-ion cell, a calcium-ion cell, a magnesium-ion cell or an aluminum-ion cell. Among these variants, energy storage cells with sodium-ion cell chemistry are preferred.

Preferably, the sodium ion-based energy storage cell comprises an electrolyte comprising at least one of the following solvents and at least one of the following conducting salts:

Organic carbonates, ethers, nitriles and mixtures thereof are particularly suitable as solvents. Preferred examples are:
Carbonates: Propylene carbonate (PC), ethylene carbonate-propylene carbonate (EC-PC), propylene carbonate-dimethyl carbonate-ethyl methyl carbonate (PC-DMC-EMC), ethylene carbonate-diethyl carbonate (EC-DEC), ethylene carbonate-dimethyl carbonate (EC-DMC), ethylene carbo-nate-ethyl methyl carbonate (EC-EMC), ethylene carbonate-dimethyl carbonate-ethyl methyl carbonate (EC-DMC-EMC), ethylene carbonate-dimethyl carbonate-diethyl carbonate (EC-DMC-DEC)
Ethers: Tetrahydrofuran (THE), 2-methyltetrahydrofuran, dimethyl ether (OME), 1,4-dioxane (DX), 1,3-dioxolane (DOL), diethylene glycol dimethyl ether (DEGDME), tetraethyl glycol dimethyl ether (TEGDME)-Nitriles: Acetonitrile (ACN), adiponitrile (AON), y-butyrolactone (GBL)

Trimethyl phosphate (TMP) and tris(2,2,2-trifluoroethyl) phosphate (TFP) can also be used.

### Preferred Conductive Salts are:

NaPF₆, sodium difluoro(oxalato)borate (NaBOB), NaBF₄, sodium bis(fluorosulfonyl)imide (NaFSI), sodium 2-trifluoromethyl-4,5-dicyanoimidazole (NaTDI), sodium bis(trifluoromethanesulfonyl)imide (NaTFSI), NaAsF₆, NaBF₄, NaClO₄, NaB(C₂O₄)₂, NaP(C₆H₄O₂)₃; NaCF₃SO₃, sodium triflate (NaTf) and Et₄NBF₄.

In preferred embodiments, additives may be added to the electrolyte. Examples of preferred additives, in particular for stabilization, are the following:

Fluoroethylene carbonate (FEC), transdifluoroethylene carbonate (DFEC), ethylene sulfite (ES), vinylene carbonate (VC), bis(2,2,2-trifluoroethyl) ether (BTFE), sodium 2-trifluoromethyl-4,5-dicyanoimidazole (NaTDI), sodium bis(fluorosulfonyl)imide (NaFSI), aluminum chloride (AICI₃), ethylene sulfate (DTD), sodium difluorophosphate (NaPO₂F₂), sodium difluoro(oxalato)borate (NaODFB), sodium difluorobisoxalatophosphate (NaDFOP) and tris(trimethylsilyl)borate (TMSB).

The negative electrode material of an energy storage cell based on sodium ions preferably comprises at least one of the following materials:
Carbon, especially hard carbon (pure or with nitrogen and/or phosphorus doping) or soft carbon or graphene-based materials (with N-doping); carbon nanotubes, graphite
Phosphorus or sulphur (conversion anode)
Polyanions: Na₂Ti₃O₇, Na₃Ti₂(PO₄)₃, TiP₂O₇, TiNb₂O₇, Na—Ti—(PO₄)₃, Na—V—(PO₄)₃
Prussian blue: low-Na variant (for systems with aqueous electrolyte)
Transition metal oxides: V₂O₅, MnO₂, TiO₂, Nb₂O₅, Fe₂O₃, Na₂Ti₃O₇, NaCrTiO₄, Na₄Ti₅O₁₂
MXenes with M=Ti, V, Cr, Mo or Nb and A=AI, Si, and Ga and X=C and/or N, e.g. Ti C₃₂
Organic: e.g. Na-Terephthalate (Na₂C₈H₂O₄)

Alternatively, a Na metal anode can also be used on the anode side.

The positive electrode material of an energy storage cell based on sodium ions comprises, for example, at least one of the following materials:
Polyanions: NaFePO₄ (Triphylit-Typ), Na₂Fe(P₂O₇), Na₄Fe₃(PO₄)₂(P₂O₇), Na₂FePO₄F, Na/Na₂[Fe_{1/2}Mn_{1/2}]PO₄F, Na₃V₂(PO₄)₂F₃, Na₃V₂(PO₄)₃, Na₄(CoMnNi)₃(PO₄)₂P₂O₇, NaCoPO₄, Na₂CoPO₄F
Silicates: Na₂MnSiO₄, Na₂FeSiO₄
Layered oxides: NaCoO₂, NaFeO₂, NaNiO₂, NaCrO₂, NaVO₂, NaTiO₂, Na(FeCo)O₂, Na(NiFeCo)₃O₂, Na(NiFeMn)O₂, and Na(NiFeCoMn)O₂, Na(NiMnCo)O₂

In addition, the electrodes of an energy storage cell preferably contain an electrode binder and/or an additive to improve the electrical conductivity. The active materials are preferably embedded in a matrix of the electrode binder, whereby the active materials are preferably used in particulate form and adjacent particles in the matrix are preferably in direct contact with each other. Conductive agents have the function of increasing the electrical conductivity of the electrodes. Common electrode binders are based on polyvinylidene fluoride (PVDF), (Na-)polyacrylate, styrene-butadiene rubber, (Na-)alginate or carboxymethyl cellulose, for example, or mixtures of different binders. Common conductive agents are carbon black, fine graphite, carbon fibers, carbon nanotubes and metal powder.

Preferably, in the energy storage cell based on sodium-ion technology, both the anode and the cathode current collector consist of aluminum or an aluminum alloy. The housing and the contact plates as well as any other current conductors within the housing can also consist of aluminum or the aluminum alloy.

### Preferred Wall Thicknesses of the Housing Cup

Preferably, the energy storage cell is characterized by at least one of the features a. to c. immediately below:
a. The radially inwardly bent opening edge of the housing cup is thicker by a factor in the range from 1.5 to 2 than the housing cup in the central section.
b. The housing cup has a wall thickness in the range from 0.1 mm to 0.4 mm in the central section, preferably in the range from 0.25 mm to 0.3 mm.
c. The radially inwardly bent opening edge of the housing cup has a wall thickness in the range from 0.15 mm to 0.8 mm, preferably in the range from 0.375 mm to 0.6 mm.

It is preferred that the immediately preceding features a. and b. as well as a. and c. are realized in combination. It is preferred that all three immediately preceding features a. to c. are realized in combination.

The bottom of the housing cup preferably has a thickness in the range from 0.2 mm to 2 mm.

Preferred Embodiments with Regard to the Greater Wall Thickness of the Opening Edge

In order to realize the greater wall thickness of the opening edge, a starting material can already be used in the production of the housing cup, which is thickened in areas intended to form the opening edge. However, it is preferable to reinforce the opening edge by bending or folding the wall of the housing cup accordingly to achieve the greater wall thickness.

Accordingly, the energy storage cell is preferably characterized by at least one of the features a. to c. immediately below:
a. The radially inwardly bent opening edge of the housing cup is double-layered.
b. The double-layered opening edge is formed by folding or bending the opening edge.
c. The double-layered opening edge has a U-shaped cross-section, in particular as a result of the folding or bending according to feature b. immediately above.

It is preferred that the immediately preceding features a. and b., preferably all three immediately preceding features a. to c., are realized in combination.

The folding or bending to form the double-layer opening edge can be done outwards or inwards. This results in different variants of the double-layered opening edge.

Preferably, the energy storage cell is characterized by at least one of the features a. to c. immediately below:
a. The double-layered opening edge has a first layer which is in direct contact with the seal which encloses the edge of the lid assembly, and a second layer parallel to the first on a side of the first layer facing away from the seal.
b. The first layer is bounded by a cut edge that points radially outwards.
c. The second layer is bounded by a cut edge that points radially outwards.

It is preferred that the immediately preceding features a. and b. or the immediately preceding features b. and c. are realized in combination.

In the variant with features a. and b., it is advantageous that the outward-facing cut edge is protected from corrosion, as it is shielded from the environment of the cell by the second layer and the outer wall of the cup.

The housing cup preferably consists of aluminum, an aluminum alloy or a sheet steel, for example a nickel-plated sheet steel.

Suitable aluminum alloys for the housing cup are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

### Contact Surface for Conductors

Preferably, the energy storage cell is characterized by at least one of the features a. to d. immediately below:
a. The opening edge bent radially inwards, in particular the double-layered opening edge, comprises a first, inner side, which is in direct contact with the seal, and a second side facing away from the seal.
b. The second side is an annulus-shaped plane surface or comprises an annulus-shaped plane surface.
c. The annulus-shaped plane surface forms a circular ring with a width in the range from 1 mm to 5 mm, preferably in the range from 1 mm to 3 mm, preferably in the range from 1.2 mm to 1.3 mm.
d. The annulus-shaped plane surface forms an angle of 90° with the wall of the housing cup in the central section.

It is preferred that the immediately preceding features a. and b. and c. or the immediately preceding features a. and b. and d. or the immediately preceding features a. to d. are realized in combination.

In these preferred embodiments, welding on a metal electrical conductor, for example a metal arrester bar, is facilitated because the surface of the radially inwardly bent opening edge is specifically enlarged and flat. The annulus-shaped plane surface is therefore preferably used for welding on the metal electrical conductor.

With regard to the electrical conductor to be welded on, it is advantageous if the annulus-shaped surface is characterized by a high degree of flatness. The energy storage cell is characterized by feature a. immediately below:
a. There is a maximum height difference of 0.08 mm between the highest and lowest points of the annulus-shaped plane surface.

The annulus-shaped plane surface located on the second side of the double-layered opening edge is therefore preferably defined by a maximum height difference of 0.08 mm between the highest and lowest points of the annulus-shaped plane surface. Or in other words: This degree of flatness preferably defines the annulus-shaped surface.

Preferably, in the case of cells with a diameter≤26 mm wide, the annulus-shaped plane surface forms a circular ring with a circular ring width in the range from 0.5 mm-1.5 mm, preferably from 1 mm to 1.5 mm.

Preferably, in the case of cells with a diameter >26 mm wide, the annulus-shaped plane surface forms a circular ring with a circular ring width in the range from 0.8 mm-3.5 mm, preferably from 1 mm to 2.5 mm.

In preferred embodiments, the radially inwardly bent opening edge of the housing cup has the greater wall thickness in the complete area of the annulus shaped plane surface. As the annulus-shaped surface is used to weld on the conductor, this ensures good shielding of the seal in this sensitive area.

### Preferred Embodiment of the Housing

Preferably, the energy storage cell is characterized by at least one of the features a. to c. immediately below:
a. The central section and the closure section are separated by an indentation that circumferentially surrounds the outside of the housing cup.
b. The housing cup has an identical maximum outer diameter in the central section and the closure section.
c. In the area of the indentation, the outer diameter of the housing cup is reduced by 4 to 12 times the wall thickness of the housing cup in this area.

It is preferred that at least the immediately preceding features a. and b. are realized in combination. It is preferred that all three immediately preceding features a. to c. are realized in combination.

### Preferred Embodiment of the Sealing Area

Preferably, the energy storage cell is characterized by at least one of the features a. to c. immediately below:
a. The annular seal comprises a first annular segment which is arranged between the indentation and the side of the lid assembly facing the inside of the housing and which is in contact, preferably in press contact, with a wall section defining the indentation and this side of the lid assembly.
b. The annular seal comprises a second annular segment which is arranged between the radially inwardly bent opening edge and the side of the lid assembly facing away from the inside of the housing, wherein the opening edge presses this second annular segment, preferably vertically, onto this side of the lid assembly.
c. The annular seal comprises a third annular segment located between the housing cup and the edge of the lid assembly, which is pressed onto the edge of the lid assembly by the wall of the housing cup in the closure zone.

It is preferred that all three immediately preceding features a. to c. are realized in combination.

Preferably, the annular seal is compressed in the closure section. It is preferably pressed against the edge of the lid assembly from several sides.

### Electrical Contacting of the Electrodes

As stated at the beginning, the present disclosure provides energy storage cells that are characterized by a high energy density. This is particularly possible if the electrode winding is efficiently connected to the housing, as described for example in WO 2017/215900 A1.

Preferably, the energy storage cell is characterized by at least one of the features a. to e. immediately below:
a. The anode of the electrode-separator assembly comprises an anode current collector having a first longitudinal edge and a second longitudinal edge parallel thereto.
b. The anode current collector comprises a main region loaded with a layer of negative electrode material and a free edge strip extending along its first longitudinal edge which is not loaded with the negative electrode material.
c. The cathode of the electrode-separator assembly comprises a cathode current collector having a first longitudinal edge and a second longitudinal edge parallel thereto.
d. The cathode current collector comprises a main region loaded with a layer of positive electrode material and a free edge strip extending along its first longitudinal edge which is not loaded with the electrode material.
e. The anode and the cathode are arranged within the electrode-separator assembly in such a way that the first longitudinal edge of the anode current collector protrudes from the first terminal end face and the first longitudinal edge of the cathode current collector protrudes from the second terminal end face of the electrode-separator assembly.

It is preferred that all five immediately preceding features a. to e. are realized in combination.

In a possible development of this preferred embodiment, it is preferred that the energy storage cell is characterized by at least one of the immediately following features a. to d:
a. the energy storage cell comprises a contact sheet metal member which sits on the first longitudinal edge of the anode current collector, covers the first terminal end face and is welded to the first longitudinal edge of the anode current collector or sits on the first longitudinal edge of the cathode current collector, covers the second terminal end face and is welded to the first longitudinal edge of the cathode current collector.
b. The contact sheet metal member is welded to the first longitudinal edge of the anode current collector or the first longitudinal edge of the cathode current collector.
c. The contact sheet metal member is connected to the bottom of the housing cup, in particular by welding.
d. The contact sheet metal member is part of the lid assembly or is directly or indirectly electrically connected to the lid assembly.

It is preferred that at least the immediately preceding features a. to c. or features a. and b. and d. are realized in combination.

In some preferred embodiments, the energy storage cell comprises a contact sheet metal member which sits on the first longitudinal edge of the anode current collector and is welded thereto, and a further contact sheet metal member which sits on the first longitudinal edge of the cathode current collector and is welded thereto.

In a possible further development, it is preferred that the energy storage cell is characterized by the immediately following feature a:
a. The first longitudinal edge of the anode current collector or the first longitudinal edge of the cathode current collector sits directly on the bottom of the housing cup and is connected to it by welding.

In this embodiment, one of the current collectors is therefore directly connected to the housing or the housing cup. In a preferred further development of this embodiment, a contact sheet metal member sits on the longitudinal edge of the other current collector. This is then electrically connected to the lid assembly.

### Preferred Embodiments of the Contact Sheet Metal Member

In a preferred embodiment, a contact sheet metal member electrically connected to the anode current collector is characterized by at least one of the features a. and b. immediately below:
a. The contact sheet metal member consists of nickel or copper or titanium or a nickel or copper or titanium alloy or stainless steel, for example of type 1.4303 or 1.4404 or of type SUS304, or of nickel-plated copper.
b. The contact sheet metal member consists of the same material as the anode current collector.

In a further preferred embodiment, a contact sheet metal member electrically connected to the cathode current collector is characterized by at least one of the features a. and b. immediately below:
a. The contact sheet metal member consists of aluminum or an aluminum alloy.
b. The contact sheet metal member consists of the same material as the anode current collector.

Preferably, the contact sheet metal member electrically connected to the anode current collector and/or the contact sheet metal member electrically connected to the cathode current collector are characterized by at least one of the features a. to g. immediately below:
a. The contact sheet metal member has a preferably uniform thickness in the range from 50 μm to 600 μm, preferably in the range from 150 μm to 350 μm.
b. The contact sheet metal member has two opposite flat sides and extends essentially in only one dimension.
c. The contact sheet metal member is a disk or a polygonal plate.
d. The contact sheet metal member is dimensioned such that it covers at least 60%, preferably at least 70%, preferably at least 80% of the first terminal end face or the second terminal end face.
e. The contact sheet metal member has at least one aperture, in particular at least one hole and or at least one slot.
f. The contact sheet metal member has at least one bead, which appears on one flat side of the contact sheet metal member as an elongated depression and on the opposite flat side as an elongated elevation, the contact sheet metal member resting with the flat side, which carries the elongated elevation, on the first longitudinal edge of the respective current collector.
g. The contact sheet metal member is welded to the first longitudinal edge of the respective current collector in the area of the bead, in particular via one or more weld seams arranged in the bead.

It is preferred that the immediately preceding features a. and b. and d. are realized in combination with each other. In a preferred embodiment, features a. and b. and d. are realized in combination with one of features c. or e. or features f. and g. Preferably, all features a. to g. are realized in combination with each other.

Covering as much of the end face as possible is important for the thermal management of the energy storage cell. The larger the cover, the easier it is to contact the first longitudinal edge of the respective current collector over its entire length. Heat formed in the electrode-separator assembly can thus be dissipated well via the contact plate.

In some embodiments, it has proven advantageous to subject the longitudinal edge of the current collector to a pretreatment before the contact sheet metal member is placed on top. In particular, at least one depression can be folded into the longitudinal edge, which corresponds to the at least one bead or the elongated elevation on the flat side of the contact sheet metal member facing the first terminal end face.

The longitudinal edge of the current collector may also have been subjected to directional forming by pre-treatment. For example, it can be bent in a defined direction.

The at least one aperture in the contact sheet metal member can, for example, be useful for impregnating the electrode-separator assembly with an electrolyte.

### Preferred Embodiments of Current Collectors and Separators

The anode current collector, the cathode current collector and the separator or separators of the cell preferably have the following dimensions:
A length in the range from 0.5 m to 25 m
A width in the range 40 mm to 145 mm

The ribbon-shaped anode, the ribbon-shaped cathode and the ribbon-shaped separator(s) are preferably spirally wound in the electrode-separator assembly formed as a winding. To produce the electrode-separator assembly, the ribbon-shaped electrodes and the ribbon-shaped separator(s) are fed to a winding device, where they are preferably wound in a spiral around a winding axis. Bonding of the electrodes and separators or contacting at elevated temperatures is usually not necessary. In some embodiments, the electrodes and the separator or separators are wound onto a cylindrical or hollow-cylindrical winding core, which is seated on a winding mandrel and remains in the winding after winding.

The winding shell can be formed by a plastic film or an adhesive tape, for example. It is also possible for the winding shell to be formed by one or more separator windings.

The current collectors of the energy storage cell have the function of electrically contacting electrochemically active components contained in the respective electrode material over as large an area as possible. Preferably, the current collectors consist of a metal or are at least metallized on the surface.

In the case of an energy storage cell designed as a lithium-ion cell suitable metals for the anode current collector include copper or nickel or other electrically conductive materials, in particular copper and nickel alloys or metals coated with nickel. In particular, materials of type EN CW-004A or EN CW-008A with a copper content of at least 99.9% can be used as copper alloys. Alloys of the type NiFe, NiCu, CuNi, NiCr and NiCrFe are particularly suitable as nickel alloys. Alloys of the type NiFe, NiCu, CuNi, NiCr and NiCrFe are particularly suitable as nickel alloys. Stainless steel can also be considered, for example type 1.4303 or 1.4404 or type SUS304.

In the case of an energy storage cell designed as a lithium-ion cell aluminum or other electrically conductive materials, including aluminum alloys, are particularly suitable as a metal for the cathode current collector.

Suitable aluminum alloys for the cathode current collector are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

Preferably, the anode current collector and/or the cathode current collector are each a ribbon-shaped metal foil with a thickness in the range from 4 μm to 30 μm.

In addition to foils, however, other strip-shaped substrates such as metallic or metallized nonwovens or open-pored metallic foams or expanded metals can also be used as current collectors.

The current collectors are preferably loaded with the respective electrode material on both sides.

It is preferred that the longitudinal edges of the separator or separators form the end faces of the electrode-separator assembly, which is formed as a winding.

### Possible Embodiments of the Lid Assembly

The cell is preferably characterized by a CID function which is integrated into the lid assembly. The CID function ensures that in the event of excessive pressure in the cell, the pressure can escape from the housing and at the same time the electrical contact between the lid assembly and the electrode-separator is disconnected.

Preferably, the energy storage cell is accordingly characterized by at least one of the features a. to c. immediately below:
a. The lid assembly comprises a metallic disk with a metallic membrane which bulges or bursts outwards in the event of overpressure inside the housing.
b. The disk with the membrane is in electrical contact with a metallic pole cap that seals the lid assembly to the outside.
c. The disk with the membrane is in electrical contact with an electrical conductor that is electrically coupled to the anode current collector or to the cathode current collector.

It is preferred that the immediately preceding features a. to c. are realized in combination.

### Possible Embodiments of the Seal

In order to additionally limit the effects of the welding process on the seal, it is preferred to use particularly temperature-resistant plastics as the sealing material.

In a further development of this preferred embodiment, it is correspondingly preferred that the energy storage cell is characterized by at least one of the immediately following features a. and b:
a. The seal consists of a plastic material that has a melting point >200° C., preferably >300° C., preferably a melting point >300° C. and <350° C.
b. The plastic material is a polyether ether ketone (PEEK), a polyimide (PI), a polyphenylene sulphide (PPS) or a polytetrafluoroethylene (PTFE).

It is preferred that the immediately preceding features a. and b. are realized in combination.

### Array of Energy Storage Cells

The array of energy storage cells is always characterized by the following features:
a. The array comprises at least two of the energy storage cells described above and
b. the array comprises at least one electrical conductor made of a metal, which is welded to the radially inwardly bent opening edges of the housing cups of the at least two energy storage cells.

The at least one conductor can, for example, be a conductor, in particular a rail, made of aluminum or an aluminum alloy.

Suitable aluminum alloys for the conductor include Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

In some preferred embodiments, the conductor is a metal sheet strip, in particular made of aluminum, with a thickness in the range from 2 to 5 mm, preferably with a thickness of 3.5 mm.

### Method

A method according to the present disclosure is characterized by the following features:
a. At least two of the energy storage cells described above and at least one electrical conductor made of metal are provided and
b. the at least one electrical conductor made of metal is connected by welding to the radially inwardly bent opening edge of one of the energy storage cells and to the radially inwardly bent opening edge of another of the energy storage cells.

Welding is preferably carried out using a laser. However, welding by means of resistance welding is also possible.

In a preferred further development, weld seams consisting of several individual lines running parallel to each other are formed by means of at least one laser in order to reduce heat input, which connect the metallic conductor and the inwardly bent opening edges to each other. This may also allow the use of seals with lower melting temperatures, for example made of a corresponding polybutylene terephthalate or a perfluoroalkoxy polymer (PFA).

The weld seam comprises a solidified fusion zone in the contact area between the metallic conductor and the inwardly bent opening edges.

The weld seam or the individual lines mentioned can also consist of many neighboring points in a row, which are preferably also formed using a laser.

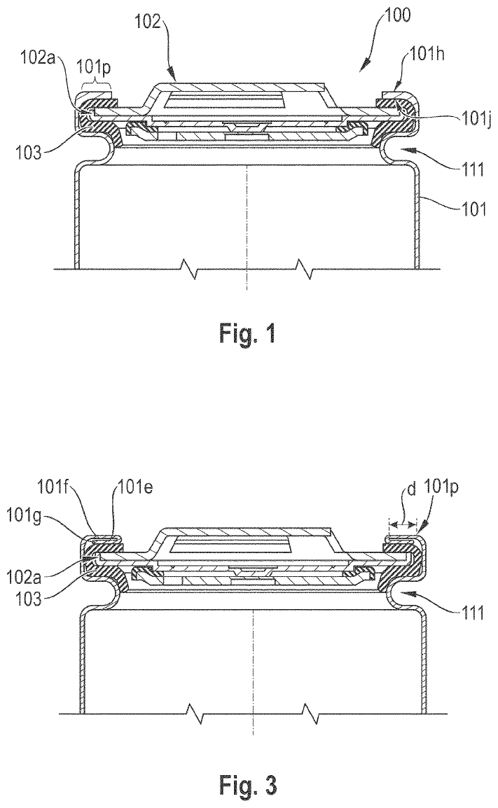

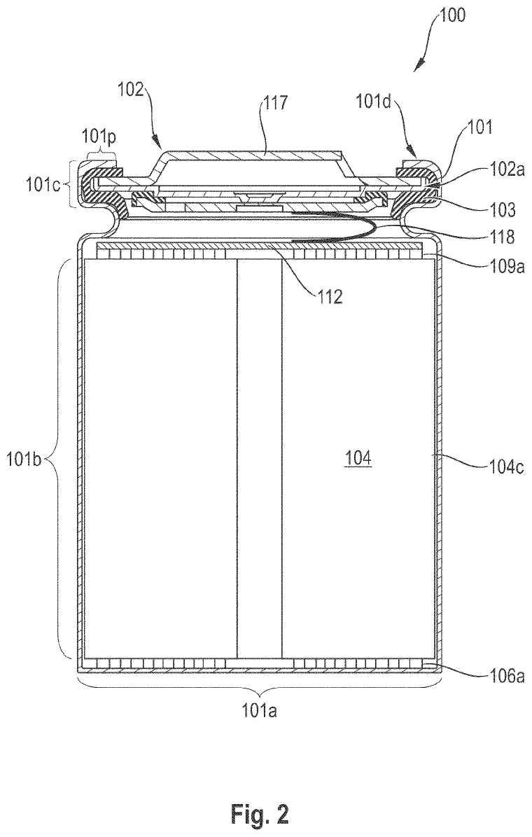

FIGS. 1 and 2 show an energy storage cell 100 with an airtight and liquid-tight housing comprising a metallic housing cup 101 with a terminal circular opening and a lid assembly 102 with a circular edge 102a which closes the circular opening. The cell further comprises an annular seal 103 made of an electrically insulating material, which encloses the circular edge 102a of the lid assembly 102 and electrically insulates the housing cup 101 and the lid assembly 102 from each other. The housing cup 101 comprises in axial sequence a bottom 101a, a central section 101b and a closure section 101c, wherein the central section 101b is cylindrical. In the central section 101b the winding shell 104c of the electrode-separator assembly 104, which is formed as a winding, is in contact with the inside of the housing cup 101, and in the closure section 101c the annular seal 103 is in contact with the lid assembly 102 and the inside of the housing cup 101. In the closure section 101c, the housing cup 101 has an opening edge 101d defining the circular opening, which is bent radially inwards over the edge 102a of the lid assembly 102, which is enclosed by the seal 103, and which positively fixes the lid assembly 102 including the seal 103 in the circular opening of the housing cup 101. The radially inwardly bent opening edge 101d of the housing cup 101 has a greater wall thickness than the housing cup 101 in the central section 101b. As a result, it is possible to carry out welding processes on the opening edge 101d without damaging the seal 103.

The cell 100 further comprises an electrode-separator assembly 104 in the form of a cylindrical winding with the sequence anode/separator/cathode, although this is not shown in detail here. Only the longitudinal edge 106a of the anode current collector 106, which protrudes from the end face 104a of the electrode-separator assembly 104, and the longitudinal edge 109a of the anode current collector 109, which protrudes from the end face 104b of the electrode-separator assembly 104, can be seen. The longitudinal edge 106a is preferably welded directly to the housing bottom 101a, in particular over its entire length. The longitudinal edge 109a is preferably welded directly to the contact plate 112, in particular over its entire length. The contact plate 112 is in turn connected to the lid assembly 102 via the electrical conductor 118, which will be described in more detail below.

The cell 100 usually has a height in the range from 60 mm to 10 mm, its diameter is preferably in the range from 20 mm to 50 mm. The housing cup 101 usually has a wall thickness in the range from 0.1 mm to 0.3 mm in the central section 101b. The radially inwardly bent opening edge 101d of the housing cup 101 is thicker by a factor in the range from 1.5 to 2 than the housing cup 101 in the central section 101b. It comprises a first, inner side, which is in direct contact with the seal 103, and a second side facing away from the seal 103. The second side comprises the circular ring-shaped plane surface 101p. The surface is shaped as an annulus with a preferred ring width in the range from 0.8 mm to 3 mm. Preferably the surface forms an angle of 90° with the wall of the housing cup 101 in the central section 101b. There is a maximum height difference of 0.08 mm between the highest and the lowest point of the annulus-shaped plane surface.

The cell 100 shown in FIG. 3 differs from the cell shown in FIGS. 1 and 2 only in that the opening edge 101d is formed in two layers as a result of a folding and has a U-shaped cross-section. The double-layered opening edge 101d has the first layer 101e, which is in direct contact with the seal 103 enclosing the edge 102a of the lid assembly 102, and the second layer 101f, which extends parallel to the first layer on the side of the first layer 101e facing away from the seal 103. The first layer 101e is bounded by the cut edge 101g, which faces radially outwards and is therefore excellently protected against corrosion. The double-layered opening edge 101d comprises a first, inner side 101j, which is in direct contact with the seal 103, and a second side 101h facing away from the seal 103. This second side 101h comprises an annular-shaped, plane surface 101p and has a ring width d in the range from 1.2 mm to 4 mm. It forms an angle of 90° with the wall of the housing cup 101 in the central section 101b.

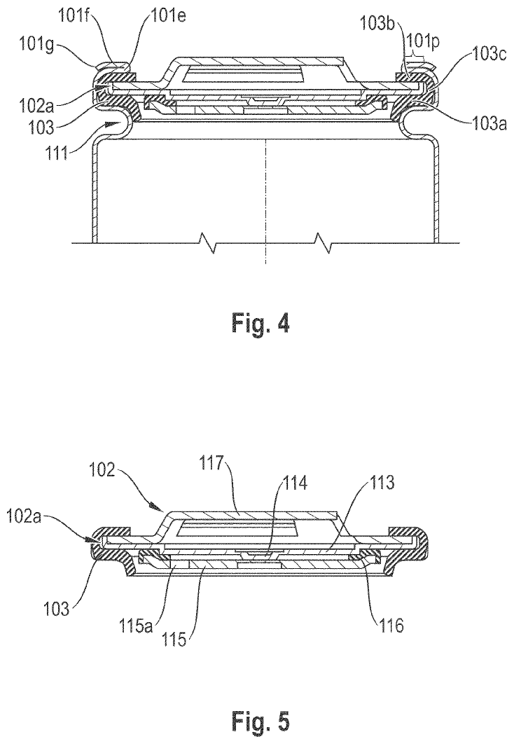

The cell 100 shown in FIG. 4 differs from the cell shown in FIGS. 1 and 2 only in that the opening edge 101d is formed in two layers as a result of a folding and has a U-shaped cross-section. The double-layered opening edge 101d has the first layer 101e, which is in direct contact with the seal 103, which encloses the edge 102a of the lid assembly 102, and the second layer 101f, which extends parallel to the first layer 101e on the side of the first layer 101e facing away from the seal 103. The second layer 101f is delimited by the cut edge 101g, which points radially outwards.

The radially inwardly bent opening edge 101d of the housing cup 101 comprises a first, inner side, which is in direct contact with the seal 103, and a second side facing away from the seal 103. The second side comprises the annulus-shaped plane surface 101p. The circular ring of the annulus has a preferred ring width in the range from 0.8 mm to 3 mm and forms an angle of 90° with the wall of the housing cup 101 in the central section 101b. There is a maximum height difference of 0.08 mm between the highest and the lowest point of the annulus-shaped plane surface.

FIG. 5 shows the lid assembly 102, which is used in the embodiments of the energy storage cell 100 as shown in FIGS. 1 to 4. This comprises the disk 113 with the metallic membrane 114, which bulges or bursts outwards in the event of excess pressure within the housing. The disk 113 with the membrane 114 is in electrical and in direct contact with the pole cap 117, which closes the lid assembly 102 to the outside. It is also in electrical contact with the inner contact disk 115, but only via the membrane 114. Otherwise, the disk 113 and the disk 115 are electrically insulated from each other by the insulator 116. If the membrane 114 bulges outwards as a result of excess pressure, which can act directly on the membrane via the aperture 115a, the electrical contact between the disk 113 and the disk 115 breaks off. At high pressures, the membrane can also burst.

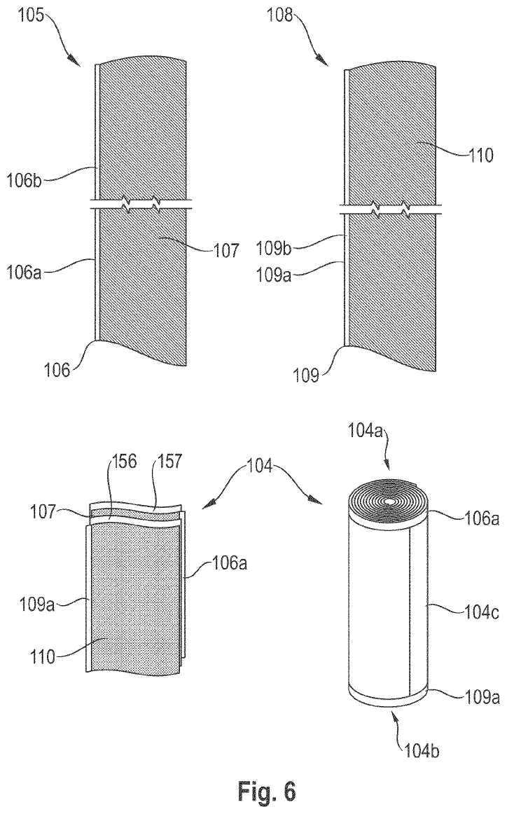

The structure of the electrode-separator assembly 104 is illustrated with reference to FIG. 6. The assembly 104 comprises the strip-shaped anode 105 with the strip-shaped anode current collector 106, which has a first longitudinal edge 106a and a second longitudinal edge parallel thereto. The anode current collector 106 is a foil made of copper or nickel. This comprises a strip-shaped main region, which is loaded with a layer of negative electrode material 107, and a free edge strip 106b, which extends along its first longitudinal edge 106a and which is not loaded with the electrode material 107. Further, the assembly 104 comprises the ribbon-shaped cathode 108 with the ribbon-shaped cathode current collector 109 having a first longitudinal edge 109a and a second longitudinal edge parallel thereto. The cathode current collector 109 is an aluminum foil. It comprises a strip-shaped main region, which is loaded with a layer of positive electrode material 110, and a free edge strip 109b, which extends along its first longitudinal edge 109a and which is not loaded with the electrode material 110. Both electrodes are shown in an unwound state.

The anode 105 and the cathode 108 are arranged offset from each other within the electrode-separator assembly 104, so that the first longitudinal edge 106a of the anode current collector 106 protrudes from the first terminal end face 104a and the first longitudinal edge 109a of the cathode current collector 109 protrudes from the second terminal end face 104b of the electrode-separator assembly 104. The offset arrangement can be seen in the illustration at the bottom left. The two ribbon-shaped separators 156 and 157 are also shown there, which separate the electrodes 105 and 108 from each other in the winding.

In the illustration at the bottom right, the electrode-separator assembly 104 is shown in wound form, as it can be used in an energy storage cell according to one of FIGS. 1 to 4. The edges 106a and 109a protruding from the end faces 104a and 104b are clearly visible. The winding shell 104c is formed by a plastic film.

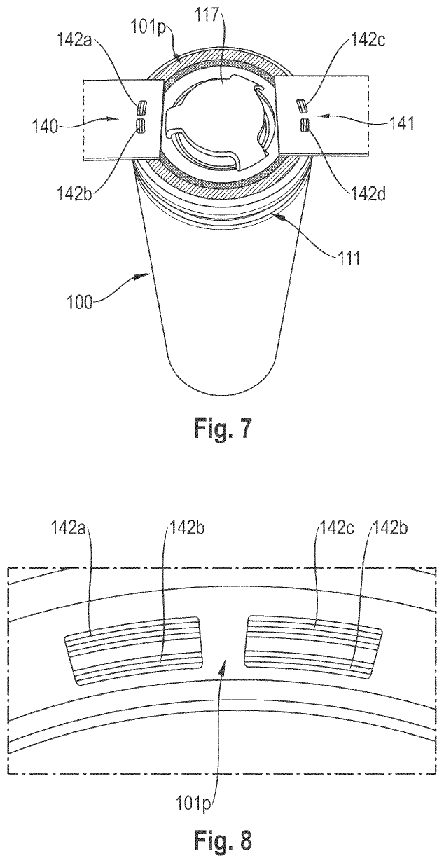

FIG. 7 shows an energy storage cell 100 as shown in FIG. 2 with two welded-on electrical conductors 140 and 141. The electrical conductors 140 and 141 each consist of a metal and are welded to the radially inwardly bent opening edge of the housing cup of the energy storage cell 100. Both electrical conductors 140 and 141 are welded onto the annulus-shaped plane surface 101p of the opening edge. The energy storage cell 100 can be connected to neighboring cells of the same type via the electrical conductors 140 and 141.

Analysis has shown that the seal located under the plane surface 101p was not damaged by the welding process.

FIG. 8 shows the underside of an inwardly bent opening edge of a housing cup onto the upper side of which an electrical conductor has been welded. It can be seen that two weld seams (142a and 142b as well as 142c and 142d) are arranged parallel to each other. It can also be seen that the weld seams are each formed from several individual weld seams running parallel to each other. Such weld seams can be formed particularly efficiently using a laser.

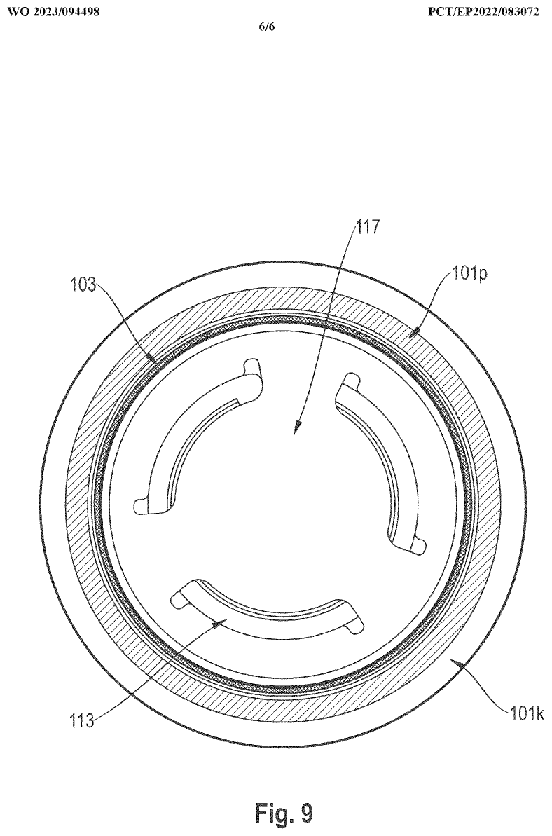

FIG. 9 shows a top view of a lid component of an energy storage cell as shown in FIG. 2. The annulus-shaped plane surface 101p as well as an edge of the seal 103 and the pole cap 117 can be seen. In the area of the annulus-shaped plane surface 101p, there is a maximum height difference of 0.08 mm between the highest and the lowest point of the circular ring-shaped plane surface. The surface 101p extends to the inner edge of the inwardly bent opening edge, under which the seal 103 protrudes. Towards the outside, the plane surface 101p adjoins the curved area 101k.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An energy storage cell, comprising:
an electrode-separator assembly in the form of a cylindrical winding with a first terminal end face, a second terminal end face, and a winding shell located therebetween, the electrode-separator assembly comprising an anode, a cathode, and at least one separator in a sequence anode/separator/cathode; and
an airtight and liquid-tight housing comprising:
a metallic housing cup with a terminal circular opening, the metallic housing cup comprising, in axial sequence, a bottom, a central section, and a closure section,
a lid assembly with a circular edge that closes the terminal circular opening,
an annular seal that encloses the circular edge of the lid assembly and electrically insulates the housing cup and the lid assembly from each other,
wherein the central section is cylindrical,
wherein the winding shell of the electrode-separator assembly contacts an inside of the metallic housing cup in the central section, and
wherein, in the closure section, the annular seal is in press contact with the lid assembly and the inside of the metallic housing cup,
wherein, in the closure section, the metallic housing cup has an opening edge that defines the circular opening and is bent radially inwards over the circular edge of the lid assembly,
wherein the opening edge positively fixes the lid assembly and the annular seal in the circular opening of the housing cup,
wherein a wall thickness of the radially inwardly bent opening edge is greater than a wall thickness of the central section.

2. The energy storage cell according to claim 1, wherein at least one of:
the wall thickness of the radially inwardly bent opening edge is thicker than the wall thickness of the central section by a factor in a range of 1.5 to 2,
the wall thickness in the central section is in a range of 0.1 mm to 0.4 mm, and/or
the wall thickness of the radially inwardly bent opening edge is in a range of 0.15 mm to 0.8 mm.

3. The energy storage cell according to claim 1, wherein at least one of:
the radially inwardly bent opening edge is double-layered,
the radially inwardly bent opening edge is formed by folding the opening edge, and/or
the radially inwardly bent opening edge has a U-shaped cross-section.

4. The energy storage cell according to claim 3, wherein at least one of:
the radially inwardly bent opening edge has (i) a first layer in direct contact with the annular seal that encloses the circular edge of the lid assembly and (ii) a second layer parallel to the first layer on a side of the first layer facing away from the annular seal,
the first layer of the radially inwardly bent opening edge is bounded by a cut edge that points radially outwards, and/or
the second layer of the radially inwardly bent opening edge is bounded by a cut edge that points radially outwards.

5. The energy storage cell according to claim 1, wherein at least one of:
the radially inwardly bent opening edge comprises a first, inner side in direct contact with the annular seal and a second side facing away from the annular seal,
the second side facing away from the annular seal is an annulus-shaped plane surface or comprises an annulus-shaped plane surface,
the annulus has a width in a range of 1 mm to 5 mm, and/or
the annulus-shaped plane surface forms an angle of 90° with a wall of the metallic housing cup in the central section.

6. The energy storage cell according to claim 1, wherein at least one of:
the central section and the closure section are separated by an indentation that circumferentially surrounds an outside of the metallic housing cup,
the housing cup has an identical maximum outer diameter in the central section and the closure section, and/or
in an area of the indentation, the outer diameter of the housing cup is reduced by 4 to 12 times a wall thickness of the housing cup in the area of the indentation.

7. The energy storage cell according to claim 6, wherein at least one of:
the annular seal comprises a first annular segment which is arranged between the indentation and a first side of the lid assembly, facing an inside of the housing, and in press contact with a wall section defining the indentation and the first side of the lid assembly,
the annular seal comprises a second annular segment arranged between the radially inwardly bent opening edge and a second side of the lid assembly facing away from the inside of the housing, wherein the opening edge presses the second annular segment onto the second side of the lid assembly, and/or
the annular seal comprises a third annular segment arranged between the housing cup and the edge of the lid assembly and pressed onto the edge of the lid assembly by a wall of the housing cup in the closure zone.

8. The energy storage cell according to claim 1, wherein at least one of:
the anode of the electrode-separator assembly comprises an anode current collector having a first longitudinal edge and a second longitudinal edge parallel thereto,
the anode current collector comprises a main region loaded with a layer of negative electrode material and a free edge strip extending along the first longitudinal edge and not loaded with the negative electrode material,
the cathode of the electrode-separator assembly comprises a cathode current collector having a first longitudinal edge and a second longitudinal edge parallel thereto,
the cathode current collector comprises a main region loaded with a layer of positive electrode material and a free edge strip extending along the first longitudinal edge and not loaded with the positive electrode material, and/or
the anode and the cathode are arranged within the electrode-separator assembly such that the first longitudinal edge of the anode current collector protrudes from the first terminal end face and the first longitudinal edge of the cathode current collector protrudes from the second terminal end face of the electrode-separator assembly.

9. The energy storage cell according to claim 8, wherein at least one of:
the energy storage cell comprises a contact plate that sits on the first longitudinal edge of the anode current collector and covers the first terminal end face or that sits on the first longitudinal edge of the cathode current collector and covers the second terminal end face and is connected thereto by welding,
the contact plate is connected to the first longitudinal edge of the anode current collector or the first longitudinal edge of the cathode current collector by welding,
the contact plate is connected to the bottom of the housing cup, and/or
the contact plate is part of the lid assembly or is directly or indirectly electrically connected to the lid assembly.

10. The energy storage cell according to claim 8, wherein the first longitudinal edge of the anode current collector or the first longitudinal edge of the cathode current collector sits directly on a bottom of the housing cup and is connected to it by welding.

11. The energy storage cell according to claim 1, wherein at least one of:
the lid assembly comprises a disk with a metallic membrane that bulges or bursts outwardly in an event of overpressure within the housing,
the disk with the membrane is in electrical contact with a pole cap that seals the lid assembly to the outside, and/or
the disk with the membrane is in electrical contact with an electrical conductor electrically coupled to the anode current collector or to the cathode current collector.

12. The energy storage cell according to claim 1, wherein at least one of:
the seal consists of a plastic material that has a melting point >300° C., and/or
the plastic material is a polyether ether ketone (PEEK), a polyimide (PI), a polyphenylene sulphide (PPS), or a polytetrafluoroethylene (PTFE).

13. An array of energy storage cells, comprising:
at least two of the energy storage cell according to claim 1; and
at least one electrical conductor made of a metal, and connected by welding to the radially inwardly bent opening edges of the housing cups of the at least two energy storage cells.

14. A method of manufacturing an array of energy storage cells, the method comprising:
providing at least two energy storage cells according to claim 1 and at least one electrical conductor made of metal; and
welding the at least one electrical conductor made of metal to the radially inwardly bent opening edge of a first of the at least two energy storage cells and to the radially inwardly bent opening edge of a second of the at least two energy storage cells.
